(19) United States
(12) Patent Application Publication
(10) Pub. No.: US 2016/0325407 A1
(43) Pub. Date: Nov. 10, 2016

(54) Method for Positioning a Component and Component Positioning Device

(71) Applicant: Bayerische Motoren Werke Aktiengesellschaft, Muenchen (DE)

(72) Inventors: Maik HAMMER, Bruckberg (DE); Johann VAN NIEKERK, Muenchen (DE)

(21) Appl. No.: 15/214,682

(22) Filed: Jul. 20, 2016

Related U.S. Application Data
(63) Continuation of application No. PCT/EP2015/053597, filed on Feb. 20, 2015.

(30) Foreign Application Priority Data
Mar. 26, 2014 (DE) 10 2014 205 612.8

(51) Int. Cl. B25B 11/00

(52) U.S. Cl. CPC B25B 11/002; B25B 11/00

(57) ABSTRACT

A method is provided for positioning a component, in particular a sheet metal component, which has a first hole or a first recess. The component with the first hole or the first recess is placed on a first support which is spherical-shaped or shaped as a spherical cap.

### CROSS REFERENCE TO RELATED APPLICATIONS

This application is a continuation of PCT International Application No. PCT/EP2015/053597, filed Feb. 20, 2015, which claims priority under 35 U.S.C. §119 from German Patent Application No. 10 2014 205 612.8, filed Mar. 26, 2014, the entire disclosures of which are herein expressly incorporated by reference.

### BACKGROUND AND SUMMARY OF THE INVENTION

The present invention relates to a method for positioning a component, particularly a sheet metal component which has a first hole or a first recess, as well as to a positioning device for such components.

In many applications, components have to be positioned in a spatially defined orientation in a simple and accurately repeatable manner.

It is an object of the invention to provide a method by which components, particularly sheet metal components, can be positioned in a spatially defined orientation in a particularly easily repeatable manner with high precision. It is a further object of the invention to create a positioning device that is suitable for this purpose.

An aspect of the invention is the idea of placing or supporting a component, which has a first hole or a first recess, by using a first support that is formed by a sphere or a spherical cap. In this case, it is a prerequisite that the diameter of the first hole or of the first recess is at least slightly smaller than the diameter of the sphere or of the spherical cap. By placing the first component onto the first support such that the first hole or the first recess is disposed on the sphere or the spherical cap, a bearing is obtained that is similar to a ball joint, i.e. the first component can be swiveled about the sphere or the spherical cap of the first support.

A spatially defined orientation of the component in the space will be obtained when the component additionally rests on a second and a third support.

According to a further aspect of the invention, the component has a second hole or a second recess and, by way of the second hole or the second recess, is placed on a second support, which is formed by a sphere or a spherical cap. Analogously to the first support, it is assumed here that the diameter of the second hole and of the second recess is at least somewhat smaller than the diameter of the sphere or of the spherical cap of the second support.

The first and/or the second hole or the first and/or the second recess may preferably be circular. However, this does not necessarily have to be the case. The first and/or the second hole may, for example, also have a triangular, quadrangular, pentagonal or any other polygonal design, in the form of a semicircle, a crescent or the like.

By placing the component in a third position of the component onto a third support, the component can be deposited in a spatially fixed manner in a defined fashion.

According to a further aspect of the invention, the first, the second and/or the third support is a magnetic support, i.e. a support that attracts ferromagnetic components, such as steel sheet components. By placing the component on a magnetic support, it is ensured that the component is attracted by the support. If the support is a sphere or a spherical cap, i.e. a magnet in the shape of a sphere or a spherical cap, and the component is placed onto the support by way of a hole provided in the component or a recess provided in the component, the component will automatically be centered with respect to the corresponding sphere or the spherical cap.

According to a further aspect of the invention it is provided that the first support is height-adjustable in a vertical direction and is adjusted to a predefined height before placing the component. In other words, the corresponding bearing point is pre-adjusted with respect to its height.

According to a further aspect of the invention, it is provided that the second support can be adjusted or displaced in a direction perpendicular to the vertical direction, i.e. in a transverse direction and, before the placing (or during the placing) of the component, is moved or displaced into a position, in which the second hole or the second recess comes to be situated on the second support.

It may further be provided that the second support can be displaced on a bearing rail, which is formed by two parallel rail side walls projecting in the vertical direction from a supporting table. If one of the supports is a sphere or a spherical cap, the latter can be disposed directly on the rail. In this case, it is essential that the diameter of the sphere or of the spherical cap is larger than the spacing of the rail side walls. If the second support is formed by a sphere, the latter can therefore be rolled directly on the rail side wall in the longitudinal direction of the bearing rail and can therefore be brought into a suitable position.

According to a further aspect of the invention, it is provided that the third support is also formed by a sphere or a spherical cap. If the third support is formed by a spherical cap, it may be provided that a flat side of the spherical cap of the third support rests from below against a bottom side of the component or the component rests on the flat side of the spherical cap.

It may be provided that the first, the second and/or the third support are arranged on a supporting table which has a hole grid, at least one of the supports being inserted into a hole of the hole grid.

As an alternative, a supporting table may also be used for the positioning of the supports, which supporting table has a regular “profiling”, at least one of the supports being inserted into a recess of the profiling. The profiling may, for example, have a plurality of circular, triangular or polygonal trough-type recesses, which are arranged in a regular pattern, for example, in a hole grid, and which are provided for receiving a sphere or a spherical cap.

As an alternative or in addition, the supporting plate may also have a plurality of oblong trough-type recesses, which are arranged in a regular pattern and are provided for receiving or centering a sphere or spherical cap. For example, a plurality of mutually parallel or mutually perpendicular oblong recesses or a plurality of pairs of mutually parallel or mutually perpendicular oblong holes may be provided in the supporting plate, in which case a sphere or a spherical cap—similarly to the above-described supporting rail—, can be placed directly on or partially into such a recess or into such an oblong hole. Similarly to the case of a supporting rail, the sphere or spherical cap can be displaced in the longitudinal direction of the corresponding recess or of the corresponding oblong hole.

As a result of the invention, costly tensioning devices currently used in vehicle body construction can be avoided or their number can be reduced. The invention is suitable particularly for the positioning of components in small piece number (small-scale series). Components positioned according to the invention can be processed subsequently, for example, in that bolts, screws or the liked are placed in the component.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a view of three spheres provided as supports for a component.

FIG. 2 is a view of a sheet metal component which is placed on the supports illustrated in FIG. 1.

FIG. 3A and 3B are views of two variants of longitudinally displaceable supports.

FIG. 4 is a view of a supporting table equipped with a hole grid.

### DETAILED DESCRIPTION OF THE DRAWINGS

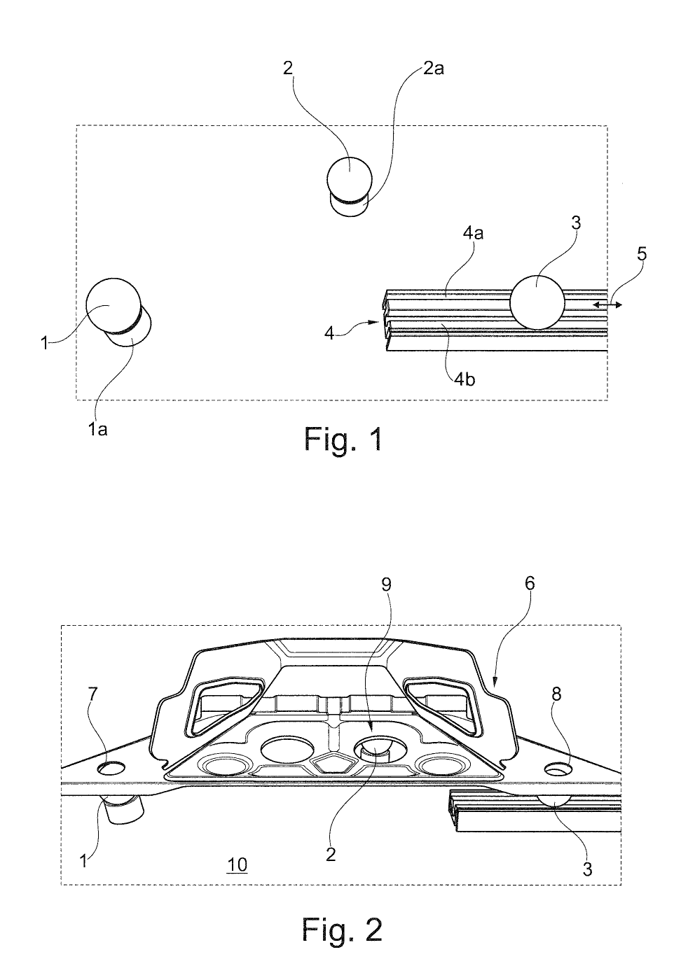

FIG. 1 illustrates an arrangement of three steel balls 1, 2, 3. The two steel balls 1 and 2 are arranged in a spatially fixed manner on an assigned support base 1a, 2a. The support bases 1a, 2a each have the shape of a cylindrical ring whose diameter is smaller than that of the ball 1 and 2, respectively.

The ball 3 rests on a bearing rail formed by two parallel rail walls 4a, 4b. As illustrated in FIG. 1, the diameter of the ball 3 is larger than the spacing of the two rail walls 4a, 4b. The ball 3 can therefore be rolled or displaced in the longitudinal direction 5 of the bearing rail 4.

FIG. 2 illustrates a steel or aluminum sheet component 6, in which a first circular hole 7 and a second circular hole 8 are provided. As shown in FIG. 2, the diameter of the holes 7, 8 is smaller than the diameter of the balls 1, 3. By means of its holes 7, 8, the component 6 is thereby disposed on the two balls 1, 3. Because the ball 3 is displaceable in the longitudinal direction of the supporting rail 7, 8, the component lies without any induced strains on the two balls 7, 8 such that the holes 7, 8 come to be centered with respect to the balls 1, 3. A rearward area 9 of the component 6 will lie on the ball 2.

Because the two balls 1, 2 are arranged in a spatially fixed manner with respect to a supporting table or a supporting plate 10 and the spacing of the two holes 7, 8 is predefined, a mere placing of the component 6 on the balls 1, 2, 3 can cause the component 6 to be moved in a very simple manner into a predefined spatial orientation. In this manner, components 6 can be aligned with high precision in an accurately repeatable manner in a defined direction in the space.

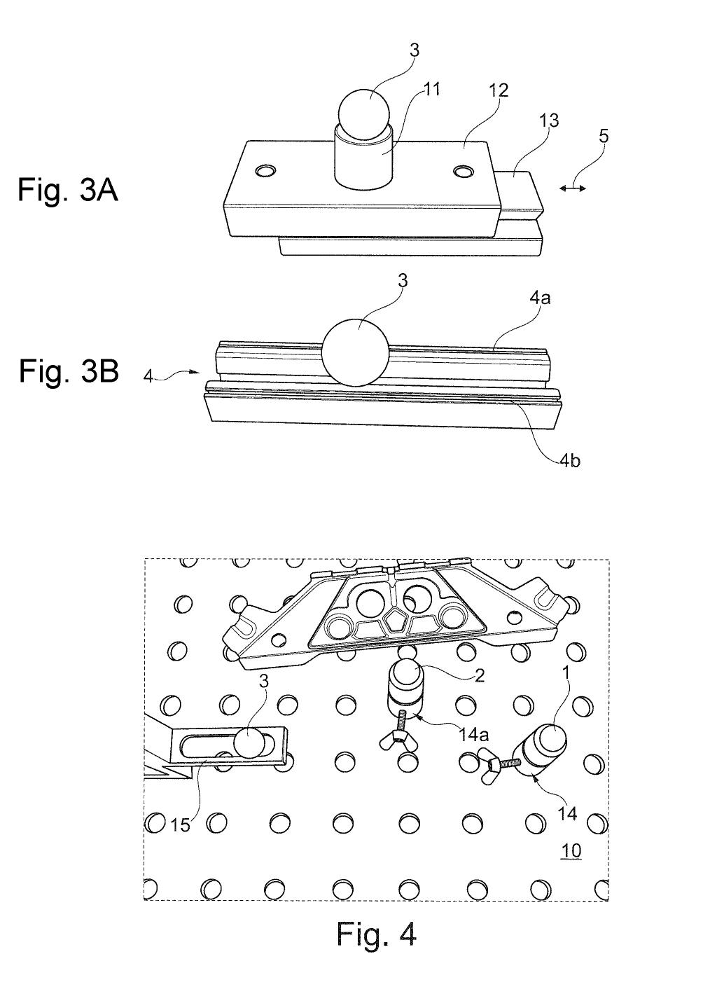

FIG. 3A is an enlarged view of the bearing rail 4 illustrated in FIG. 1.

As an alternative to the bearing rail 4, the ball 3 could also be arranged by way of a support base 11, which is fixedly connected with a slide block 12 as shown in FIG. 3B. The slide block 12 is longitudinally displaceable in the direction of the arrow 5 arranged on a supporting rail 13. The supporting rail 13 may be coupled with the slide block 12, for example, by way of a dovetail guide.

FIG. 4 illustrates a supporting table 10 which is equipped with a regular-distribution hole grid. In the case of the embodiment illustrated here, the supports 1, 2, 3 formed by the balls are fixed on the hole grid of the supporting table 10. The ball 1 can be adjusted in its height by way of a vertically adjustable holding element 14, i.e. in a direction perpendicular to the supporting table 10. In the same manner, the ball 2 can be adjusted in its height by way of a vertically adjustable adjusting element 14a. Here, the ball 3 can be displaced in the longitudinal direction of an oblong hole 15 provided in a supporting part.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method of positioning a component, the method comprising the acts of:
providing the component with a first hole or a first recess;
placing the component with the first hole or the first recess onto a first support formed by a sphere or a spherical cap.

2. The method according to claim 1, further comprising the acts of:
providing the component with a second hole or a second recess; and
placing the component, via the second hole or the second recess, onto a second support formed by a sphere or a spherical cap.

3. The method according to claim 2, wherein one or both of the first and second holes or the first and second recesses is circular.

4. The method according to claim 2, further comprising the act of:
placing the component onto a third support at a point of the component.

5. The method according to claim 4, wherein one or more of the first, second, or third supports are magnetic, whereby during the placing the component is attracted by the magnetic support.

6. The method according to claim 1, further comprising the act of:
adjusting the first support, via a height-adjustable mechanism, to a predefined height in a vertical direction before placing the component onto the first support.

7. The method according to claim 2, further comprising the act of:
adjusting the first support, via a height-adjustable mechanism, to a predefined height in a vertical direction before placing the component onto the first support.

8. The method according to claim 6, further comprising the act of:
before or during the placing of the component onto the second support, moving the second support, via an adjustable mechanism, in a direction perpendicular to a vertical direction into a position in which the second hole or the second recess of the component will come to be situated on the second support.

9. The method according to claim 8, wherein the second support is displaceable on a bearing rail formed by two parallel rail side walls that project in a vertical direction.

10. The method according to claim 9, wherein the sphere or the spherical cap of the second support lies directly on the bearing rail.

11. The method according to claim 4, wherein the third support is formed by a sphere or a spherical cap.

12. The method according to claim 11, wherein a flat side of the spherical cap of the third support rests against a bottom side of the component.

13. The method according to claim 4, wherein the first, second, and third supports are arranged on a supporting table having a hole grid, at least one of the supports being inserted in a hole of the hole grid or being directly or indirectly fixed on a hole of the hole grid.

14. The method according to claim 4, wherein the first, second and third supports are arranged on a supporting table having a regular profiling, at least one of the supports being placed in a recess of the profiling.

15. The method according to claim 14, wherein the profiling comprises circular trough-shaped recesses that are arranged in a regular pattern on the supporting table.

16. The method according to claim 14, wherein the profiling comprises oblong-hole shaped recesses or elevations configured as a pair of rails arranged in a regular pattern.

17. The method according to claim 1, wherein the component is a sheet metal component.

18. A positioning device for positioning a component having a first hole or a first recess, the positioning device comprising:
at least a first support configured as a sphere or a spherical cap, wherein
the component is placeable on the at least first support by way of the first hole or the first recess of the component.

19. The positioning device according to claim 18, wherein the positioning device comprises three supports, each of which is formed by a sphere or a spherical cap.

20. The positioning device according to claim 19, further comprising a supporting table on which at least one of the three supports is inserted into a hole of a hole grid of the supporting table or is directly or indirectly fixed on a hole of the hole grid.
